(19) United States
(12) Patent Application Publication
(10) Pub. No.: US 2026/0061243 A1
(43) Pub. Date: Mar. 5, 2026

(54) HALOGEN DECONTAMINATION FROM METAL-CONTAINING MATERIALS USING CHEMICAL MODIFICATION

(71) Applicant: Tokyo Electron Limited, Tokyo (JP)

(72) Inventors: Steven Grzeskowiak, Albany, NY (US); Yu-Hao Tsai, Albany, NY (US); Eric Chih-Fang Liu, Albany, NY (US); Akiteru Ko, Albany, NY (US)

(21) Appl. No.: 18/824,390

(22) Filed: Sep. 4, 2024

(51) Int. Cl. A62D 3/34; A62D 3/40; A62D 101/43; A62D 101/47; A62D 101/49

(52) U.S. Cl. CPC A62D 3/34; A62D 3/40; A62D 2101/43; A62D 2101/47; A62D 2101/49

(57) ABSTRACT

A method for decontaminating residual halogen species in a processed metal-containing layer without breaking vacuum includes processing a metal-containing layer (such as a metal oxide layer) using a halogen-containing process gas to form a processed metal-containing layer that includes residual halogen species, and chemically modifying the residual halogen species to form modified residual species using a reactive gas to decontaminate the residual halogen species. Decontamination may include neutralization and/or removal of the residual halogen species. The metal-containing layer may be an organometal oxide photoresist and processing with the halogen-containing process gas may form a patterned photoresist layer contaminated with the residual halogen species. The modified residual species may be further treated using dinitrogen plasma (pure or with additional gases) and/or additional reactive gases, both of which may be combined with maintaining and higher or lower temperature during the treatment.

### TECHNICAL FIELD

The present invention relates generally to semiconductor fabrication, and, in particular embodiments, to systems and methods for decontaminating residual halogen species from metal-containing materials.

### BACKGROUND

The formation of microscale and nanoscale structures within a workpiece, such as within an integrated circuit (e.g., semiconductor fabrication), involves a series of processing techniques that include forming, patterning, and removing various layers of material on a substrate. Many different types of materials may be formed in and on the substrate during the fabrication process, including semiconductor materials such as silicon, metallic materials such as copper, dielectric materials such as silicon dioxide. Various compounds may be used to alter the materials on the substrate. For example, wet processes may use a liquid phase compound (or mixture of compounds). Similarly, dry processes may use compounds in the gas phase, plasma phase, or a combination thereof.

Lithography processes enable the transfer of patterns onto a substrate, and include photolithography processes that use structured actinic radiation (light of a specific wavelength or narrow range of wavelengths) to pattern a layer of photosensitive material (photoresist) on the substrate. During the exposure process, the actinic radiation causes a change in the chemical structure of the photoresist that either makes it more susceptible (positive tone) or less susceptible (negative tone). The exposed photoresist layer is then developed to remove the desired regions of the photoresist leaving the pattern behind on the substrate. Development can be a wet or a dry process, with wet development being more common and leveraging solubility differences between exposed and unexposed regions. However, dry development processes are gaining popularity due to various possible benefits, such as enhanced pattern resolution, reduced defectivity, and the potential to use a range of materials as photoresists.

Halogen-containing compounds, such as halides, halocarbons (e.g., fluorocarbons (FCs), hydrofluorocarbons (HFCs) chlorofluorocarbons (CFCs), and so on), and others, are used for various fabrication processes including as etchants, precursors, cleaning agents, and more for both wet and dry processes. Processes that use some halogen-containing compounds have the drawback of leaving behind residual halogen species (i.e., halogens themselves or compounds that include halogen) in and on the substrate that can cause detrimental effects during downstream processes. After undesirable residual halogen species are left on the substrate, decontamination processes may be performed (e.g., processes that seek to remove the residual halogen species or neutralize the potential for adverse effects caused by the residual halogen species). However, halogen decontamination processes often cause other problems, such as damaging other materials on the substrate or resulting in insufficient halogen decontamination (while also decreasing throughput and increasing process complexity). For at least these reasons, improved methods for the decontamination of halogen species may be desirable.

### SUMMARY

In accordance with an embodiment of the invention, a method for decontaminating residual halogen species in a processed metal oxide layer without breaking vacuum includes processing a metal oxide layer using a halogen-containing process gas to form a processed metal oxide layer including residual halogen species, and chemically modifying the residual halogen species to form modified residual species using a reactive gas to decontaminate the residual halogen species.

In accordance with another embodiment of the invention, a method of removing halogen contamination in a processed metal oxide layer without breaking vacuum includes processing a metal oxide layer using a halogen-containing process gas to form a processed metal oxide layer including residual organometal oxyhalide species, chemically modifying the residual organometal oxyhalide species using a reactive gas to form modified residual species, and selectively etching the modified residual species using a direct dinitrogen plasma to remove the modified residual species.

In accordance with still another embodiment of the invention, a processing system includes a processing chamber, a substrate holder disposed in the processing chamber, a process gas source fluidically coupled to the processing chamber, a reactive gas source fluidically coupled to the processing chamber, and a controller operationally coupled to the process gas source and the reactive gas source. The substrate holder is configured to support a substrate including a metal oxide layer exposed at a frontside of the substrate. The process gas source is configured to flow a halogen-containing process gas. The reactive gas source configured to flow a reactive gas. The controller includes one or more processors and at least one non-transitory computer-readable medium storing a program including instructions that, when executed by the one or more processors, cause the processing system to process the metal oxide layer using the halogen-containing process gas to form a processed metal oxide layer including residual halogen species, and chemically modify the residual halogen species to form modified residual species using the reactive gas to decontaminate the residual halogen species.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 schematically illustrates an example halogen decontamination process that includes a reactive step during which residual halogen species remaining in a metal oxide layer after a processing step using a halogen-containing process gas are chemically modified using a reactive gas to decontaminate the halogen contamination in accordance with embodiments of the invention;

FIG. 2 schematically illustrates an example halogen decontamination process that includes a reactive step during which residual organotin oxybromide species remaining in an organotin oxide layer after a dry development process using a bromine-containing gas are chemically modified using a fluorine-containing gas to neutralize the halogen contamination in accordance with embodiments of the invention;

FIG. 3 schematically illustrates an example halogen decontamination process that includes a reactive step during which residual organotin oxybromide species remaining in an organotin oxide layer after a dry development process using a bromine-containing gas are chemically modified using a chlorine-containing gas and then a thermal process is used to remove the halogen contamination in accordance with embodiments of the invention;

FIG. 4 schematically illustrates another example halogen decontamination process that includes a reactive step during which residual organotin oxybromide species remaining in an organotin oxide layer after a dry development process using a bromine-containing gas are chemically modified using a chlorine-containing gas and then a dinitrogen plasma process is used to remove the halogen contamination in accordance with embodiments of the invention;

FIG. 5 illustrates a flowchart of an example method for decontaminating residual halogen species that use halogen decontamination processes including a reactive step in accordance with embodiments of the invention;

FIG. 6 illustrates a flowchart of another example method for decontaminating residual halogen species that use halogen decontamination processes including a reactive step in accordance with embodiments of the invention;

FIG. 7 schematically illustrates an example chemical processing system usable to perform halogen decontamination processes including a reactive step in accordance with embodiments of the invention; and

FIG. 8 schematically illustrates an example plasma processing system usable to perform halogen decontamination processes including a reactive step in accordance with embodiments of the invention;

Corresponding numerals and symbols in the different figures generally refer to corresponding parts unless otherwise indicated. The figures are drawn to clearly illustrate the relevant aspects of the embodiments and are not necessarily drawn to scale. The edges of features drawn in the figures do not necessarily indicate the termination of the extent of the feature.

### DETAILED DESCRIPTION OF ILLUSTRATIVE EMBODIMENTS

The making and using of various embodiments are discussed in detail below. It should be appreciated, however, that the various embodiments described herein are applicable in a wide variety of specific contexts. The specific embodiments discussed are merely illustrative of specific ways to make and use various embodiments, and should not be construed in a limited scope. Unless specified otherwise, the expressions “around”, “approximately”, and “substantially” signify within 10%, and preferably within 5% of the given value or, such as in the case of substantially zero, less than 10% and preferably less than 5% of a comparable quantity.

After a substrate is processed using a halogen-containing compound, residual halogen species, such as residual halides, may remain in or on materials of the substrate. For example, the residual material may result from incomplete or undesirable chemical reactions, inadequate system purging that leads to the deposition or redeposition of chemical species such as process byproducts, or insufficient cleaning processes. Although residual halogen species may be detrimental in a variety of contexts, one example is after a development process of a metal-containing photoresist (e.g., a photoresist including metal complexes, such as an organometal oxide photoresist) to form a patterned photoresist layer. A halogen-containing compound, such as hydrogen bromide (HBr), may be used during the development of the metal-containing resist and leave behind residual halogen species (e.g., halides, such as metal halide species) that cause detrimental effects to downstream processes, such as mask loss or further contamination to other materials on the same substrate or contamination to other substrates (e.g., other wafers during transport or storage). The problem of halogen contamination may be especially pronounced for dry development processes, which do not have the option of using a liquid to wash away residual material.

Conventional methods address contamination of different types in a variety of different contexts. One conventional method removes residual silicon fluoride species from exposed silicon-containing surfaces, such as silicon, silicon dioxide, or silicon nitride surfaces, using an ammonia plasma treatment. In some variations, hydrogen or nitrogen radicals formed in a remote plasma are used to bond with residual silicon halide species (e.g., residual silicon fluoride species) to form hydrogen halide species, such as hydrogen fluoride (HF). However, these methods are specifically tailored to remove halogens that have formed bonds with silicon (Si—X bonds).

Another conventional method seeks to avoid future metal contamination of other wafers due to outgassing using one or a combination of a myriad of possible processing techniques, including both wet and dry processes performed on both the frontside and back side of the substrate, such as exposing the substrate to plasma, exposing the substrate to light in the visible, ultraviolet, and infrared range, exposed the substrate to heat such as during bakes throughout all stages processing, exposing the substrate to assorted processing gases, purges, inert gas sweeps, chamber cleans, and so on. Conceptually, these conventional methods attempt to increase the volatility of residual metals so they can be more easily removed, although some conventional methods try to increase the stability of the residual metals so that they do not outgas to other wafers. Yet, these conventional metal decontamination methods are specifically developed to address metal contamination. Moreover, they employ a scattershot approach with many different techniques and chemicals (some of which can be harmful to other materials on the wafer) with no clear picture of which combinations are most effective.

In accordance with embodiments herein described, the invention proposes a method for decontaminating residual halogen species left behind in or on a processed metal-containing layer using selective chemical reactions before removal from a vacuum environment. For example, the residual halogen species may be chemically modified without exciting plasma to form modified residual species that are either no longer a concern (neutralized) or that are easier to remove using subsequent processing steps, such as one or more additional chemical treatments, plasma treatments, thermal treatments, or a combination thereof. In some embodiments, the initial chemical modification step may be combined with plasma etch treatment that uses dinitrogen (N₂ gas). In other embodiments, the entire decontamination process is performed without exciting plasma. In still other embodiments, a separate plasma etch treatment selective to the modified residual species may be performed to etch away the modified residual species.

The embodiments described herein may have various advantages over conventional methods. For example, embodiment methods for decontaminating a residual halogen species may have the benefit of selectively removing unwanted halogen-containing species that could adversely affect downstream processes. The methods may advantageously be performed without breaking vacuum (and in situ in the same chamber in some embodiments) and use only dry processes. Additionally, the embodiment methods described herein may be performed with little or no damage to other materials, layers, or films also present on the substrate. Furthermore, in the specific context of development of metal-containing photoresists subsequently used as etch masks, the embodiment methods may provide the advantage of enabling dry development (e.g., gas-phase development) by mitigating or eliminating mask loss from residual halogen species as well as metal contamination caused by the residual halogen species.

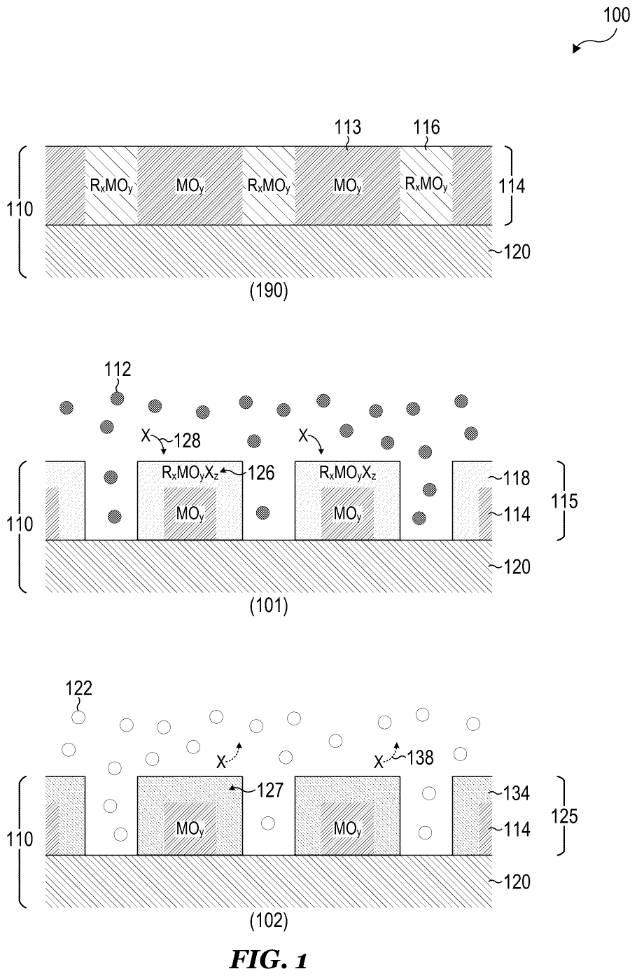

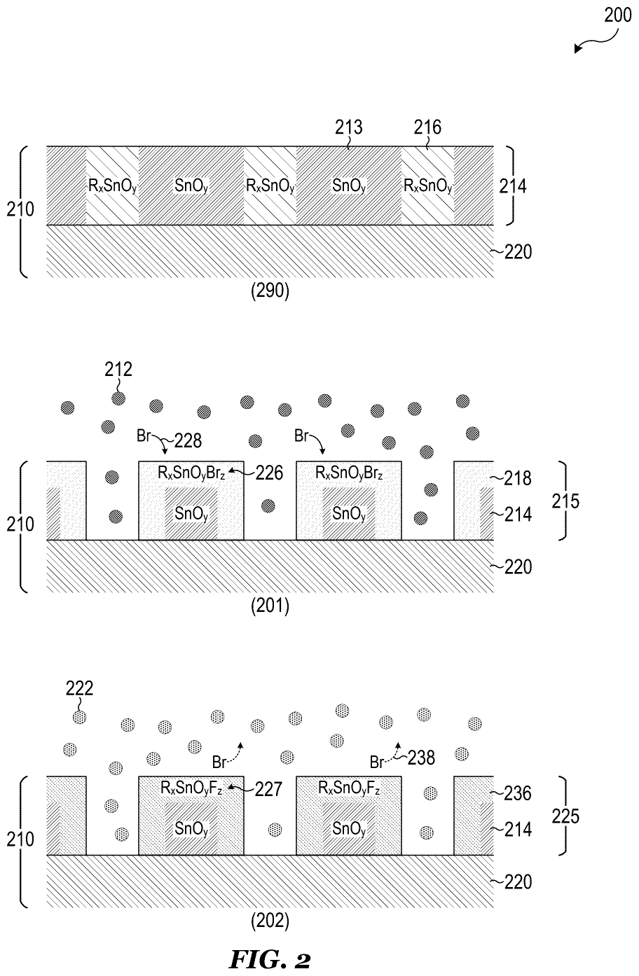

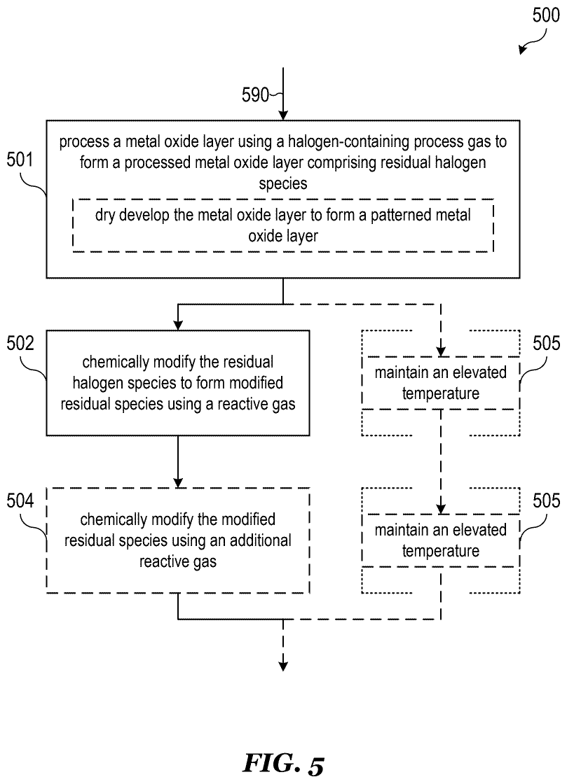

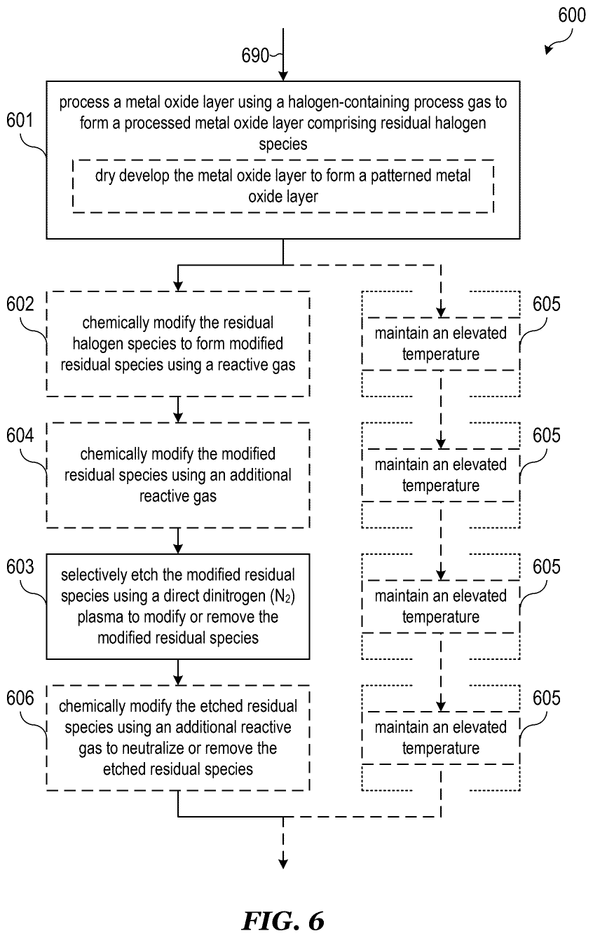

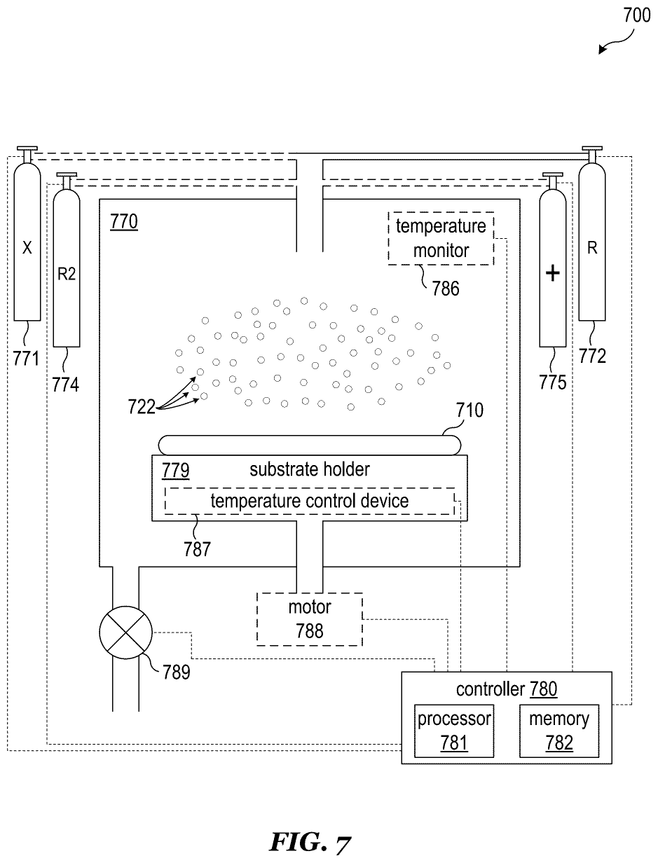

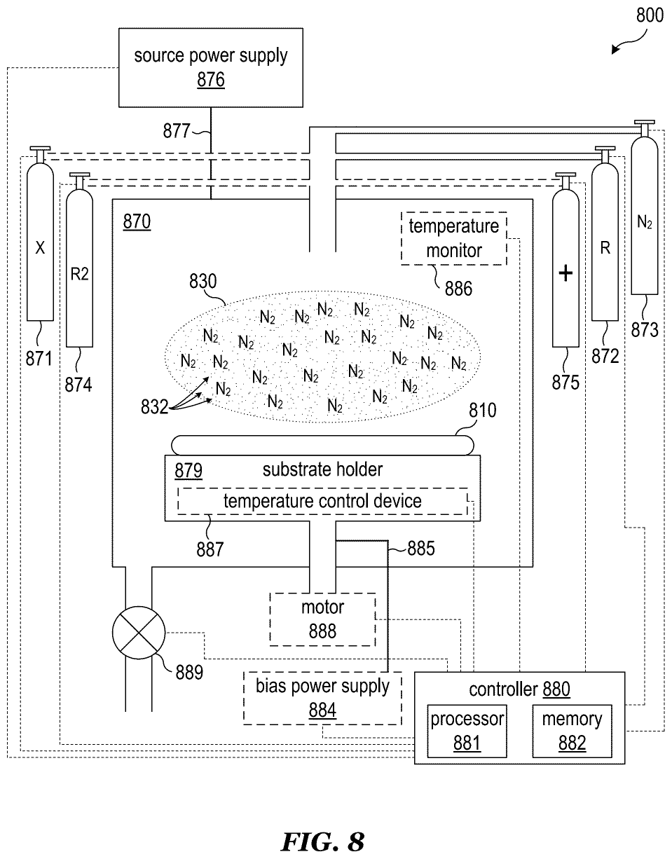

Embodiments provided below describe various systems and methods for decontaminating residual halogen species from metal-containing materials (e.g., metal oxides, metal complexes such as organometal materials, etc.) and in particular embodiments, to systems and methods using decontamination processes with a reactive step performed before removal from a vacuum environment. The following description describes the embodiments. FIG. 1 is used to describe an example halogen decontamination process that includes a reactive step to decontaminate halogen contamination. Three more example halogen decontamination processes are described using FIGS. 2-4. Two embodiment methods for decontaminating residual halogen species are described using FIGS. 5 and 6 while two example processing systems are described using FIGS. 7 and 8.

FIG. 1 schematically illustrates an example halogen decontamination process that includes a reactive step during which residual halogen species remaining in a metal oxide layer after a processing step using a halogen-containing process gas are chemically modified using a reactive gas to decontaminate the halogen contamination in accordance with embodiments of the invention.

Referring to FIG. 1, a halogen decontamination process 100 includes a processing step 101 and a reactive step 102 performed on a substrate 110 including a metal oxide layer 114 (e.g., on a frontside of a wafer) that is in an initial state 190. During the processing step 101, the metal oxide layer 114 is processed using a halogen-containing process gas 112 to form a processed metal oxide layer 115. In this specific example, the processing step 101 is a development process of the metal oxide layer 114, which is configured to be photoresist material that is sensitive to actinic radiation, but the processing step 101 may be any processing step that uses a halogen-containing process gas.

The metal oxide layer 114 may include various types of metal (and metalloids) and may include more than one type of metal. In some embodiments, the metal oxide layer 114 includes tin (Sn) and includes tin oxide in one embodiment. In one embodiment, the metal oxide layer 114 includes titanium (Ti). Of course, other metals may also be used, including other transition metals such as zirconium (Zr), hafnium (Hf), and zinc (Zn), other post-transition metals such as indium (In), and metalloids such as antimony (Sb) and tellurium (Te).

Other components other than metal species and oxygen may also be included in the metal oxide layer 114. For example, organic species may also be included. In one embodiment, the metal oxide layer 114 is an organometal oxide layer (e.g., a layer including metal complexes with a metal and one or more organic species, such as butyl groups, along with oxygen species, such as hydroxide). In one embodiment, the metal oxide layer 114 is an organotin oxide layer. Alternatively, the metal oxide layer 114 may instead be a pure metal layer or a layer that contains metal species and elements other than oxygen.

In the initial state 190, the metal oxide layer 114 has already been exposed to the actinic radiation to form exposed metal oxide material 113 and unexposed metal oxide material 116, as shown. For example, the metal oxide layer 114 may include organometal oxide species (conceptually labeled as RₓMO_{y} species). The exposure to actinic radiation may cleave bonds between metal oxide species (MO_{y}) and organic species (Rₓ) allowing crosslinking between metal oxide species that increases resistance to development processes. The processing step 101 removes the unexposed metal oxide material 116 (the metal oxide layer 114 has a positive tone here, but the opposite is also possible) and forms the processed metal oxide layer 115, which in this case is a developed photoresist layer (e.g., a patterned metal oxide layer that may be used as a mask layer) exposing an underlying layer 120 that may be any suitable material.

During the processing step 101, the halogen-containing process gas 112 is provided (e.g., flowed into a processing chamber including the substrate 110) and leaves residual halogen species 126 in a halogen contaminated region 118 from reactions involving incorporated halogens 128 (e.g., fluorine, chlorine, bromine, etc.) and the metal oxide layer 114 (MO_{y}). The halogen contaminated region 118 may result from incomplete reactions between the halogen-containing process gas 112 and the metal oxide layer 114. Although residual halogen species are not always a problem, for the purposes of this discussion, the residual halogen species 126 are considered halogen contamination in the processed metal oxide layer 115.

In various embodiments, the halogen-containing process gas 112 includes bromine and includes hydrogen bromide (HBr) gas in one embodiment. When bromine is included in the halogen-containing process gas 112, the incorporated halogens 128 are bromine, but of course other halogens may also be incorporated into the halogen contaminated region 118 and depend on the halogen-containing process gas or gas mixture being used. In various embodiments, the reactive step 102 is a chemical dry development process that is performed without exciting plasma. In other embodiments, plasma may be excited from the halogen-containing process gas 112 during the reactive step 102. In some embodiments, the reactive step 102 also includes controlling the temperature at the metal oxide layer 114 (whether above or below the ambient).

In various embodiments, the residual halogen species 126 include residual organometal oxyhalide species (conceptually labeled as RₓMO_{y}X_{z} species), although many other species that include halogens bonded to other elements are possible and may also be present in some concentration. The residual halogen species 126 (including RₓMO_{y}X_{z} and other species) may include metal-halogen bonds (M-X) bonds.

The residual halogen species 126 such as the RₓMO_{y}X_{z} species may cause various undesirable effects for downstream processes. For example, the RₓMO_{y}X_{z} species may result in mask loss or further contamination (such as metal contamination) of other materials on the substrate 110 or on other substrates, such as other wafers that are being stored or transported, for example. Therefore, it may be desirable to decontaminate the residual halogen species 126 (and particularly RₓMO_{y}X_{z}, in some cases).

In the reactive step 102, a reactive gas 122 is provided (e.g., flowed into a processing chamber including the substrate 110) that reacts with the residual halogen species 126 and forms a modified region 134 in a treated metal oxide layer 125. The reactive step 102 modifies the residual halogen species 126 to form modified residual species 127 and reduce or eliminate contamination of the processed metal oxide layer 115. In some cases that are subsequently described in more detail, the reactive step 102 may be an intermediate step leading to further decontamination of the substrate 110. Advantageously, the reactive gas 122 may be selected to react with the residual halogen species 126 without causing damage or further contamination to other materials of the substrate 110. In various embodiments, the reactive step 102 is performed without exciting plasma. In some cases, specific plasma environments may be utilized concurrently with the reactive step 102 while still avoiding undesirable damage to other materials of the substrate 110.

One or more decontamination strategies may be employed, the details of which may depend on specific aspects of the RₓMO_{y}X_{z} species and other residual halogen species in a given application. For example, the RₓMO_{y}X_{z} species may be modified (e.g., chemically) to no longer cause some or all of the undesirable effects (neutralization). One specific neutralization strategy may be to replace the halogen with a different species (even a different halogen) to decrease reactivity, volatility, or some other potentially harmful aspect of the RₓMO_{y}X_{z} species. This may result in removed halogen-containing material 138 and leave behind the modified residual species 127.

As another example of a decontamination strategy, some or all of the RₓMO_{y}X_{z} species may be removed, such as by removing the halogen from the RₓMO_{y}X_{z} species (e.g., as the removed halogen-containing material 138) to form one or more species that are more desirable (e.g., halogen-free), such as RₓMO_{y} species, MO_{y} (which may crosslink with other MO_{y} species), and Rₓ species. The removal of the RₓMO_{y}X_{z} species may also be performed in a multistep process, and may include an intermediate modification step that replaces one or more species of the RₓMO_{y}X_{z} species with a different species (even a different halogen) to increase reactivity, volatility, or some other aspect of the RₓMO_{y}X_{z} species that facilitates subsequent removal.

In various embodiments, the reactive gas 122 includes a fluorine-containing gas and the modified residual species 127 is fluorine-containing residual species (e.g., including metal-fluorine bonds M-F). In some embodiments the reactive gas 122 includes a xenon fluoride species (e.g., XeF₂, XeF₄, XeF₆) and includes xenon difluoride (XeF₂) in one embodiment. Of course other fluorine-containing gases may be included, such as difluorine (F₂), various fluorocarbon species (CₓF_{y}), and others. The reactive gas 122 may also include other reactive gases, such as dichlorine (Cl₂), dihydrogen (H₂), dinitrogen (N₂), sulfur dioxide (SO₂), and water vapor (H₂O), among others.

Other than including a metal-containing material, such as the metal oxide layer 114, the composition, quantity, and configuration of materials is not limited. For example, the substrate 110 may be any suitable substrate, such as an insulating, conducting, or semiconducting substrate with one or more layers (e.g., including the metal oxide layer 114 and the underlying layer 120, in addition to other layers) disposed thereon. For example, the substrate 110 may be a semiconductor wafer, such as a silicon wafer, including various layers, structures, and devices (e.g., forming integrated circuits). In one embodiment, the substrate 110 includes silicon. In another embodiment, the substrate 110 includes silicon germanium (SiGe). In still another embodiment, the substrate 110 includes gallium arsenide (GaAs). Of course, many other suitable materials, semiconductor or otherwise, may be included in the substrate 110 as may be apparent to those of skill in the art.

FIG. 2 schematically illustrates an example halogen decontamination process that includes a reactive step during which residual organotin oxybromide species remaining in an organotin oxide layer after a dry development process using a bromine-containing gas are chemically modified using a fluorine-containing gas to neutralize the halogen contamination in accordance with embodiments of the invention. The halogen decontamination process of FIG. 2 may be a specific implementation of other halogen decontamination processes described herein such as the halogen decontamination process of FIG. 1, for example. Similarly labeled elements may be as previously described.

Referring to FIG. 2, a halogen decontamination process 200 includes a processing step 201 and a reactive step 202 performed on a substrate 210 including a metal oxide layer 214 that is in an initial state 290 where the metal oxide layer 214 has already been exposed to actinic radiation to form exposed metal oxide material 213 and unexposed metal oxide material 216. It should be noted that here and in the following a convention has been adopted for brevity and clarity wherein elements adhering to the pattern [x02] where ‘x’ is the figure number may be related implementations of a reactive step in various embodiments. For example, the reactive step 202 may be similar to the reactive step 102 except as otherwise stated. An analogous convention has also been adopted for other elements as made clear by the use of similar terms in conjunction with the aforementioned numbering system.

During the processing step 201, the metal oxide layer 214 is processed using a halogen-containing process gas 212 to form a processed metal oxide layer 215, which in this case is a developed photoresist layer exposing an underlying layer 220. In this specific example, the halogen-containing process gas 212 is a bromine-containing gas (e.g., HBr) and the processed metal oxide layer 215 is an organotin oxide layer (including species conceptually labeled as RₓSnO_{y}). Residual halogen species 226 (which here include residual organotin oxybromide species RₓSnO_{y}Br_{z} that may have tin-bromine bonds Sn—Br) are left behind in a halogen contaminated region 218 by the processing step 201 from reactions involving incorporated halogens 228 (Br) and the metal oxide layer 214 (SnO_{y}).

In the reactive step 202, a reactive gas 222 is provided that reacts with the residual halogen species 226 and forms a less volatile metal oxide layer 236 (a specific example of a modified region, such as modified region 134 of FIG. 1) including modified residual species 227 in a treated metal oxide layer 225. In this specific example, the reactive gas 222 is a fluorine containing gas (e.g., XeF₂, F₂, etc.) and the modified residual species 227 include residual fluorine-containing species that may include tin-fluorine bonds (Sn—F), such as organotin oxyfluoride species (RₓSnO_{y}F_{z}). During the reactive step 202, removed halogen-containing material 238 (Br, which may be species such as HBr, for example) is also produced as fluorine replaces bromine within the processed metal oxide layer 215. Advantageously, the volatility of the modified residual species 227 may be less than that of the residual halogen species 226 (such as from the presence of the Sn—F bonds instead of Sn—Br bonds).

At this stage, the decontamination of the processed metal oxide layer 215 from the residual halogen species 226 may be considered complete (such as when the decontamination strategy is to neutralize the residual halogen species 226). For example, the volatility (and possibly other detrimental properties) of the bromine species may be the source of undesirable downstream effects while the decreased volatility or other desirable properties of the fluorine species may not result in the undesirable effects. In other embodiments, the neutralization strategy is an intermediate step in a larger decontamination process.

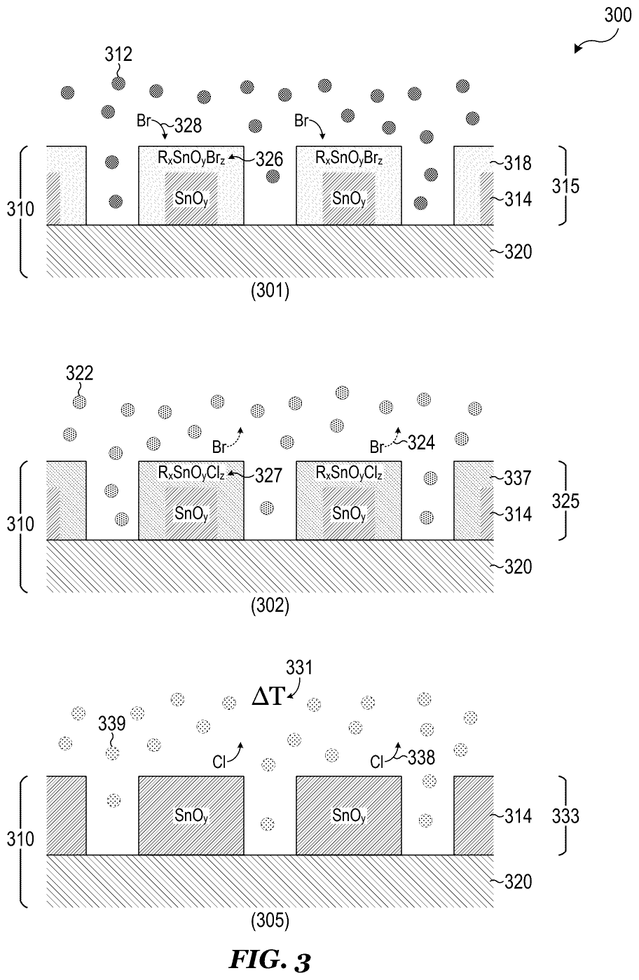

FIG. 3 schematically illustrates an example halogen decontamination process that includes a reactive step during which residual organotin oxybromide species remaining in an organotin oxide layer after a dry development process using a bromine-containing gas are chemically modified using a chlorine-containing gas and then a thermal process is used to remove the halogen contamination in accordance with embodiments of the invention. The halogen decontamination process of FIG. 3 may be a specific implementation of other halogen decontamination processes described herein such as the halogen decontamination process of FIG. 1, for example. Similarly labeled elements may be as previously described.

Referring to FIG. 3, a halogen decontamination process 300 includes a processing step 301, a reactive step 302, and a thermal step 305 performed on a substrate 310 including a metal oxide layer 314 (e.g. that is in an initial state as previously described). As before, during the processing step 301, the metal oxide layer 314 is processed using a halogen-containing process gas 312 to form a processed metal oxide layer 315, which in this case is a developed photoresist layer exposing an underlying layer 320. In this specific example, the halogen-containing process gas 312 is a bromine-containing gas (e.g., HBr) and the processed metal oxide layer 315 is an organotin oxide layer (including RₓSnO_{y} species).

Residual halogen species 326 (which here include residual organotin oxybromide species RₓSnO_{y}Br_{z} that may have tin-bromine bonds Sn—Br) are left behind in a halogen contaminated region 318 by the processing step 301 from reactions involving incorporated halogens 328 (Br) and the metal oxide layer 314 (SnO_{y}). In the reactive step 302, a reactive gas 322 is provided that reacts with the residual halogen species 326 and forms a more volatile metal oxide layer 337 (a specific example of a modified region, such as modified region 134 of FIG. 1) including modified residual species 327 in a treated metal oxide layer 325.

In this specific example, the reactive gas 322 is a chlorine-containing gas (e.g., Cl₂) and the modified residual species 327 includes residual chlorine-containing species that may include tin-chlorine bonds (Sn—Cl), such as organotin oxychloride species (RₓSnO_{y}Cl_{z}). During the reactive step 302, replaced halogen species 324 (Br, which may be species such as HBr, for example) are also produced as chlorine replaces bromine within the processed metal oxide layer 315. Advantageously, the volatility of the modified residual species 327 may be more than that of the residual halogen species 326 (such as from the presence of the Sn—Cl bonds instead of Sn—Br bonds).

Although in some cases, the residual chlorine species may not be considered contamination or may mitigate undesirable downstream effects compared to bromine species, it may also be desirable to remove the modified residual species 327. During the thermal step 305, the temperature of the metal oxide layer 314 and/or the environment within which the substrate 310 is located is controlled (e.g. increased or decreased to desired levels relative to temperatures that would be experienced in the absence of temperature control). In various embodiments, the temperature at the metal oxide layer 314 is maintained at an elevated temperature (a maintained temperature 331). For example, the increased volatility of the modified residual species 327 (containing chlorine) may be advantageously leveraged to remove the residual halogen species 326 as removed halogen-containing material 338 (Cl species, such as HCl, for example) from the baked metal oxide layer 333 during the thermal step 305.

In some embodiments, the maintained temperature 331 at the metal oxide layer 314 is a high temperature (e.g., about 100° C. to about 250° C.). In other embodiments, (e.g., when plasma is not used and the halogen decontamination process 300 is performed in a single chemical processing chamber), the maintained temperature 331 at the metal oxide layer 314 a very high temperature (e.g., about 250° C. to about 400° C.) and is in the range of about 300° C. to about 400° C. in one embodiment. Though not necessarily applicable to this example, other embodiments of the halogen decontamination process 300 may decrease the temperate at the metal oxide layer 314 to low temperatures below ambient temperatures, or even to very low temperatures (e.g., down to about −50° C. for example).

The thermal step 305 is distinct from the reactive step 302 in that the metal oxide layer 314 is at a different (e.g., lower) temperature during the reactive step 302. The thermal step 305 may be performed under vacuum or in the presence of an additional reactive gas 339, which may be the same or different than the reactive gas 322. In various embodiments, the additional reactive gas 339 is a reactive gas that enhances the removal process of the modified residual species 327, such as a nitrogen-containing gas or a hydrogen-containing gas. Of course, the additional reactive gas 339 may include any of the reactive gases usable during the reactive step 302.

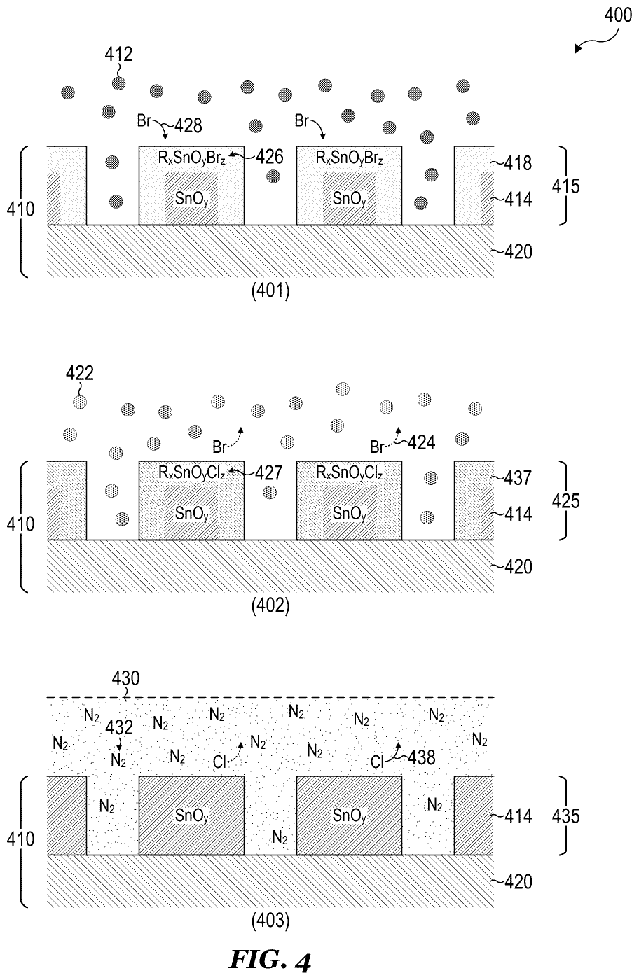

FIG. 4 schematically illustrates another example halogen decontamination process that includes a reactive step during which residual organotin oxybromide species remaining in an organotin oxide layer after a dry development process using a bromine-containing gas are chemically modified using a chlorine-containing gas and then a dinitrogen plasma process is used to remove the halogen contamination in accordance with embodiments of the invention. The halogen decontamination process of FIG. 4 may be a specific implementation of other halogen decontamination processes described herein such as the halogen decontamination process of FIG. 1, for example. Similarly labeled elements may be as previously described.

Referring to FIG. 4, a halogen decontamination process 400 includes a processing step 401, a reactive step 402, and a plasma etch treatment 403 performed on a substrate 410 including a metal oxide layer 414 (e.g. that is in an initial state as previously described). As before, during the processing step 401, the metal oxide layer 414 is processed using a halogen-containing process gas 412 to form a processed metal oxide layer 415, which in this case is a developed photoresist layer exposing an underlying layer 420. In this specific example, the halogen-containing process gas 412 is a bromine-containing gas (e.g., HBr) and the processed metal oxide layer 415 is an organotin oxide layer (including RₓSnO_{y} species).

Residual halogen species 426 (which here include residual organotin oxybromide species RₓSnO_{y}Br_{z} that may have tin-bromine bonds Sn—Br) are left behind in a halogen contaminated region 418 by the processing step 401 from reactions involving incorporated halogens 428 (Br) and the metal oxide layer 414 (SnO_{y}). In the reactive step 402, a reactive gas 422 is provided that reacts with the residual halogen species 426 and forms a more volatile metal oxide layer 437 (a specific example of a modified region, such as modified region 134 of FIG. 1) including modified residual species 427 in a treated metal oxide layer 425.

In this specific example, the reactive gas 422 is a chlorine-containing gas (e.g., Cl₂) and the modified residual species 427 includes residual chlorine-containing species that may include tin-chlorine bonds (Sn—Cl), such as organotin oxychloride species (RₓSnO_{y}Cl_{z}). During the reactive step 402, replaced halogen species 424 (Br, which may be species such as HBr, for example) are also produced as chlorine replaces bromine within the processed metal oxide layer 415. Advantageously, the volatility of the modified residual species 427 may be more than that of the residual halogen species 426 (such as from the presence of the Sn—Cl bonds instead of Sn—Br bonds).

Again, the residual chlorine species may not be considered contamination or may mitigate undesirable downstream effects compared to bromine species, but it may also be desirable to remove the modified residual species 427. During the plasma etch treatment 403, the metal oxide layer 414 is exposed to plasma excited from a N₂-containing precursor gas 432 (i.e. an N₂ plasma 430, which may be a direct or remote plasma) forming an etched metal oxide layer 435 and removing some or all of the modified residual species 427 as removed halogen-containing material 438 (Cl species, such as HCl, for example). In one embodiment, the N₂-containing precursor gas 432 is a pure N₂ gas. The N₂-containing precursor gas 432 may include other gases, such as being diluted with argon (Ar) and/or dioxygen (O₂). For example, the inclusion of O₂ gas may enhance the removal of the modified residual species 427 in some cases. Other gases may also be included, such as inert gases like helium (He) and xenon (Xe), as well as reactive gases, such as a fluorine-containing gas like XeF₂ or F₂, or CₓF_{y}, or other reactive gases like H₂, Cl₂, SO₂, and so on.

In various embodiments, the residual halogen species 426 may be volatilized using Cl₂ as part of the reactive gas 422 and a fluorine-containing gas may be included in the N₂-containing precursor gas 432 to aid in the removal process or neutralize the modified residual species 427 that are not being removed be the N₂ plasma 430. In one embodiment, XeF₂ is included in the N₂-containing precursor gas 432. In other embodiments, the reactive gas 422 includes fluorine instead of chlorine and the reactive step 402 is combined with or overlaps the plasma etch treatment 403 so that the metal oxide layer 414 is exposed to a N₂ plasma 430 that includes fluorine, such as from XeF₂.

FIG. 5 illustrates a flowchart of an example method for decontaminating residual halogen species that use halogen decontamination processes including a reactive step in accordance with embodiments of the invention. The method of FIG. 5 may be combined with other methods and performed using the systems and apparatuses as described herein. For example, the method of FIG. 5 may be combined with any of the embodiments of FIGS. 1-4 and 6-8. Although shown in a logical order, the arrangement and numbering of the steps of FIG. 5 are not intended to be limited. The method steps of FIG. 5 may be performed in any suitable order or concurrently with one another as may be apparent to a person of skill in the art.

Referring to FIG. 5, a method 500 for decontaminating residual halogen species in a processed metal oxide layer without breaking vacuum includes a processing step 501 during which a metal oxide layer beginning in an initial state 590 is processed using a halogen-containing process gas to form a processed metal oxide layer including residual halogen species. For example, the processing step 501 may be a dry development process where the metal oxide layer is developed to form a patterned metal oxide layer.

After the processing step 501, the residual halogen species is chemically modified using a reactive gas to form modified residual species. The temperature may be controlled during some or part of the reactive step 502. For example, the method 500 may include an optional thermal step 505 during which the temperature at the metal oxide layer is maintained at an elevated temperature. Alternatively, the temperature at the metal oxide layer may be controlled to be lower during the reactive step 502, such as to control the selectivity of the chemical reaction, for example.

While the method 500 may be complete in some embodiments after the reactive step 502 (e.g., the residual halogen species may be decontaminated, having been neutralized and/or removed), the method 500 may also include one or more additional reactive steps 504 that may use other reactive gases or different temperature environments (such performed concurrently with a continued or different thermal step 505) to further decontaminate the residual halogen species until a desired level of decontamination is reached. One specific example of an implementation of method 500 that includes the reactive step 502 and at least partially concurrent additional reactive and thermal steps (504, 505) may be the halogen decontamination process 300 of FIG. 3 when the thermal step includes a reactive gas.

FIG. 6 illustrates a flowchart of another example method for decontaminating residual halogen species that use halogen decontamination processes including a reactive step in accordance with embodiments of the invention. The method of FIG. 6 may be combined with other methods and performed using the systems and apparatuses as described herein. For example, the method of FIG. 6 may be combined with any of the embodiments of FIGS. 1-5 and 7-8. Although shown in a logical order, the arrangement and numbering of the steps of FIG. 6 are not intended to be limited. The method steps of FIG. 6 may be performed in any suitable order or concurrently with one another as may be apparent to a person of skill in the art.

Referring to FIG. 6, a method 600 for decontaminating residual halogen species in a processed metal oxide layer without breaking vacuum includes a processing step 601 during which a metal oxide layer beginning in an initial state 690 is processed using a halogen-containing process gas to form a processed metal oxide layer including residual halogen species. For example, the processing step 601 may be a dry development process where the metal oxide layer is developed to form a patterned metal oxide layer.

After the processing step 601, the residual halogen species may be chemically modified using a reactive gas to form modified residual species. The temperature may be controlled during some or part of the reactive step 602. For example, the method 600 may include an optional thermal step 605 during which the temperature at the metal oxide layer is maintained at an elevated temperature. Alternatively, the temperature at the metal oxide layer may be controlled to be lower during the reactive step 602, such as to control the selectivity of the chemical reaction, for example. One or more additional reactive steps 604 that may use other reactive gases or different temperature environments (such performed concurrently with a continued or different thermal step 605) may also be included to further modify the modified residual species.

The method 600 also includes a plasma etch treatment 603 during which the modified residual species is selectively etched using a direct N₂ plasma to modify or remove the modified residual species. In one embodiment, the modified residual species is formed concurrently with the plasma etch treatment 603, such as when reactive gases are included during the plasma etch treatment 603. The temperature at the metal oxide layer may be controlled during the plasma etch treatment 603 as with any included reactive steps. Further, the etched residual species (e.g., that are not removed during the plasma etch treatment 603) may be further chemically modified (e.g., neutralized) or removed during one or more post plasma reactive steps 606.

The embodiment halogen decontamination processes described herein may be performed by various processing systems configured to perform the various steps in one or more chambers while maintaining a vacuum environment. Two specific examples of processing systems usable to perform halogen decontamination processes including a reactive step are shown in FIGS. 7 and 8 where FIG. 7 schematically illustrates an example chemical processing system and where FIG. 8 schematically illustrates an example plasma processing system in accordance with embodiments of the invention. The processing systems of FIGS. 7 and 8 may be used to perform any of the methods and processes described herein, such as the halogen decontamination processes of FIGS. 1-4 and the methods of FIGS. 5 and 6, for example. Moreover, the processing systems of FIGS. 7 and 8 may be combined in some embodiments (e.g., including both a chemical processing chamber and a plasma processing chamber in the same vacuum environment). Similarly labeled elements may be as previously described.

Referring to FIG. 7, a chemical processing system 700 (e.g., a system configured for dry chemical reactions, such was without plasma capabilities or with only remote plasma capabilities) includes a processing chamber 770 configured to contain a substrate 710. In some embodiments, the chemical processing system 700 may be configured to maintain elevated temperatures above those of plasma processing systems (e.g., very high temperatures up to 400° C., and higher). A substrate holder 779 is disposed within the processing chamber 770 and configured to support the substrate 710. A reactive gas source 772 (e.g., a gas source that includes one or more reactive gases) is fluidically coupled to the processing chamber 770 and configured to supply a reactive gas 722 into the processing chamber 770. An optional process gas source 771 may also be included, such as when the processing chamber 770 is used for both a processing step and a reactive step in the same chamber. An optional additional reactive gas source 774 (e.g., a gas source that includes one or more additional reactive gases) may also be included, such as when a decontamination process includes additional reactive steps. An optional additional gas source 775 may also be included to supply other gases as needed, such as carrier gases, additional reactants, or others.

An exhaust valve 789 may be included to control evacuation of the processing chamber 770 during the plasma etching processes. An optional temperature monitor 786 may be included to monitor and/or aid in controlling the temperature of the substrate 710 and the environment in the processing chamber 770. An optional temperature control device 787 may be included to raise or lower the temperature of the substrate 710 above or below the equilibrium temperature during the plasma etching processes. An optional motor 788 may also be included to improve process uniformity.

A controller 780 is operatively coupled to the various components of the chemical processing system 700, including the gas sources, power supplies, and valves. The controller 780 includes one or more processors 781 and at least one memory 782 (i.e., a non-transitory computer-readable medium) that stores a program including instructions that, when executed by the one or more processors 781, perform some or all of the halogen decontamination processes described herein. For example, the memory 782 may have volatile memory (e.g., random access memory (RAM)) and non-volatile memory (e.g., flash memory). Alternatively, the program may be stored in physical memory at a remote location, such as in cloud storage. The processor 781 may be any suitable processor, such as the processor of a microcontroller, a general-purpose processor (such as a central processing unit (CPU), a microprocessor, a field-programmable gate array (FPGA), an application-specific integrated circuit (ASIC), and others.

Referring to FIG. 8, a plasma processing system 800 (e.g., a system configured to excite plasma from process gases, whether direct, remote, or a combination thereof) includes a processing chamber 870 configured to contain a substrate 810. In some embodiments, the plasma processing system 800 may be configured to maintain elevated temperatures (e.g., high temperatures up to 250° C., but may be higher in some embodiments). A substrate holder 879 is disposed within the processing chamber 870 and configured to support the substrate 810.

A reactive gas source 872 (e.g., a gas source that includes one or more reactive gases) is fluidically coupled to the processing chamber 870 and configured to supply a reactive gas into the processing chamber 870. An optional process gas source 871 may also be included, such as when the processing chamber 870 is used for both a processing step and a reactive step in the same chamber. A dinitrogen-containing precursor source 873 is also fluidically coupled to the processing chamber 870 and is configured to supply a N₂-containing precursor gas 832 into the processing chamber 870. An optional additional reactive gas source 874 (e.g., a gas source that includes one or more additional reactive gases) may also be included, such as when a decontamination process includes additional reactive steps. An optional additional gas source 875 may also be included to supply other gases as needed, such as carrier gases, additional reactants, or others.

The plasma processing system 800 is configured to generate plasma during the plasma etching processes. Specifically, a source power supply 876 is configured to couple source power 877 to the processing chamber 870 in order to excite plasma from gases within the chamber (i.e., at least N₂ plasma 830 from the N₂-containing precursor gas 832, as well as other plasmas, if desired). An optional bias power supply 884 may also be included and may be configured to supply bias power 885 to the substrate holder 879 (and the substrate 810), such as to accelerate ions in the plasma towards the substrate 810.

An exhaust valve 889 may be included to control evacuation of the processing chamber 870 during the plasma etching processes. An optional temperature monitor 886 may be included to monitor and/or aid in controlling the temperature of the substrate 810 and the environment in the processing chamber 870. An optional temperature control device 887 may be included to raise or lower the temperature of the substrate 810 above or below the equilibrium temperature during the plasma etching processes. An optional motor 888 may also be included to improve process uniformity.

A controller 880 is operatively coupled to the various components of the plasma processing system 800, including the gas sources, power supplies, and valves. The controller 880 includes one or more processors 881 and at least one memory 882 (i.e., a non-transitory computer-readable medium) that stores a program including instructions that, when executed by the one or more processors 881, perform some or all of the halogen decontamination processes described herein.

Example embodiments of the invention are summarized here. Other embodiments can also be understood from the entirety of the specification as well as the claims filed herein.

Example 1. A method for decontaminating residual halogen species in a processed metal oxide layer without breaking vacuum, the method including: processing a metal oxide layer using a halogen-containing process gas to form a processed metal oxide layer including residual halogen species; and chemically modifying the residual halogen species to form modified residual species using a reactive gas to decontaminate the residual halogen species.

Example 2. The method of example 1, where the metal oxide layer is a tin oxide layer, the halogen-containing process gas is hydrogen bromide gas, and processing the metal oxide layer includes dry developing the tin oxide layer using the hydrogen bromide gas, the processed metal oxide layer being a patterned tin oxide layer.

Example 3. The method of one of examples 1 and 2, where the reactive gas is a fluorine-containing gas, where chemically modifying the residual halogen species includes replacing a halogen other than fluorine with fluorine using the fluorine-containing gas to decrease volatility of the modified residual species compared to the residual halogen species.

Example 4. The method of one of examples 1 to 3, further including: maintaining a temperature between about 100° C. and about 250° C. during some or all of chemically modifying the residual halogen species.

Example 5. The method of one of examples 1 to 4, further including: chemically modifying the modified residual species at an elevated temperature using an additional reactive gas.

Example 6. The method of one of examples 1 to 5, further including: treating the modified residual species using a direct dinitrogen (N₂) plasma.

Example 7. The method of example 6, further including: chemically modifying the modified residual species at an elevated temperature using an additional reactive gas after treating the modified residual species with the direct N₂ plasma.

Example 8. The method of one of examples 6 and 7, where treating the modified residual species includes selectively etching the modified residual species using the direct N₂ plasma to remove the modified residual species.

Example 9. The method of one of examples 1 to 5, where the method is performed without exciting plasma.

Example 10. The method of example 9, further including: maintaining a temperature between about 300° C. and about 400° C. during some or all of chemically modifying the residual halogen species to remove the residual halogen species.

Example 11. A method of removing halogen contamination in a processed metal oxide layer without breaking vacuum, the method including: processing a metal oxide layer using a halogen-containing process gas to form a processed metal oxide layer including residual organometal oxyhalide species; chemically modifying the residual organometal oxyhalide species using a reactive gas to form modified residual species; and selectively etching the modified residual species using a direct dinitrogen (N₂) plasma to remove the modified residual species.

Example 12. The method of example 11, where the direct N₂ plasma is excited from a pure N₂ gas.

Example 13. The method of one of examples 11 and 12, where the reactive gas is a chlorine-containing gas, where chemically modifying the residual organometal oxyhalide species includes replacing a halogen other than chlorine with chlorine using the chlorine-containing gas to increase volatility of the modified residual species compared to the residual halogen species.

Example 14. The method of one of examples 11 to 13, where the reactive gas includes a xenon fluoride species.

Example 15. The method of example 14, where chemically modifying the residual organometal oxyhalide species and selectively etching the modified residual species are performed concurrently.

Example 16. The method of one of examples 11 to 14, where chemically modifying the residual organometal oxyhalide species and selectively etching the modified residual species do not overlap in time.

Example 17. A processing system including: a processing chamber; a substrate holder disposed in the processing chamber and configured to support a substrate including a metal oxide layer exposed at a frontside of the substrate; a process gas source fluidically coupled to the processing chamber and configured to flow a halogen-containing process gas; a reactive gas source fluidically coupled to the processing chamber and configured to flow a reactive gas; and a controller operationally coupled to the process gas source and the reactive gas source, the controller including one or more processors and at least one non-transitory computer-readable medium storing a program including instructions that, when executed by the one or more processors, cause the processing system to process the metal oxide layer using the halogen-containing process gas to form a processed metal oxide layer including residual halogen species, and chemically modify the residual halogen species to form modified residual species using the reactive gas to decontaminate the residual halogen species.

Example 18. The processing system of example 17, where the processing system is a plasma processing system, and where the instructions further cause the plasma processing system to dry develop the metal oxide layer using plasma excited from the halogen-containing process gas, the processed metal oxide layer being a patterned metal oxide layer.

Example 19. The processing system of example 18, further including: a dinitrogen-containing (N₂-containing) precursor source fluidically coupled to the processing chamber and configured to flow an N₂-containing precursor, where the instructions further cause the plasma processing system to selectively etch the modified residual species using a direct N₂ plasma excited from the N₂-containing precursor to remove the modified residual species from the patterned metal oxide layer, where chemically modifying the residual halogen species is performed without exciting plasma.

Example 20. The processing system of example 17, where the processing system is a chemical processing system, and where processing the metal oxide layer and chemically modifying the residual halogen species are both performed without exciting plasma.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for decontaminating residual halogen species in a processed metal oxide layer without breaking vacuum, the method comprising:
processing a metal oxide layer using a halogen-containing process gas to form a processed metal oxide layer comprising residual halogen species; and
chemically modifying the residual halogen species to form modified residual species using a reactive gas to decontaminate the residual halogen species.

2. The method of claim 1, wherein
the metal oxide layer is a tin oxide layer,
the halogen-containing process gas is hydrogen bromide gas, and
processing the metal oxide layer comprises dry developing the tin oxide layer using the hydrogen bromide gas, the processed metal oxide layer being a patterned tin oxide layer.

3. The method of claim 1, wherein the reactive gas is a fluorine-containing gas, wherein chemically modifying the residual halogen species comprises replacing a halogen other than fluorine with fluorine using the fluorine-containing gas to decrease volatility of the modified residual species compared to the residual halogen species.

4. The method of claim 1, further comprising:
maintaining a temperature between about 100° C. and about 250° C. during some or all of chemically modifying the residual halogen species.

5. The method of claim 1, further comprising:
chemically modifying the modified residual species at an elevated temperature using an additional reactive gas.

6. The method of claim 1, further comprising:
treating the modified residual species using a direct dinitrogen (N₂) plasma.

7. The method of claim 6, further comprising:
chemically modifying the modified residual species at an elevated temperature using an additional reactive gas after treating the modified residual species with the direct N₂ plasma.

8. The method of claim 6, wherein treating the modified residual species comprises selectively etching the modified residual species using the direct N₂ plasma to remove the modified residual species.

9. The method of claim 1, wherein the method is performed without exciting plasma.

10. The method of claim 9, further comprising:
maintaining a temperature between about 300° C. and about 400° C. during some or all of chemically modifying the residual halogen species to remove the residual halogen species.

11. A method of removing halogen contamination in a processed metal oxide layer without breaking vacuum, the method comprising:
processing a metal oxide layer using a halogen-containing process gas to form a processed metal oxide layer comprising residual organometal oxyhalide species;
chemically modifying the residual organometal oxyhalide species using a reactive gas to form modified residual species; and
selectively etching the modified residual species using a direct dinitrogen (N₂) plasma to remove the modified residual species.

12. The method of claim 11, wherein the direct N₂ plasma is excited from a pure N₂ gas.

13. The method of claim 11, wherein the reactive gas is a chlorine-containing gas, wherein chemically modifying the residual organometal oxyhalide species comprises replacing a halogen other than chlorine with chlorine using the chlorine-containing gas to increase volatility of the modified residual species compared to the residual halogen species.

14. The method of claim 11, wherein the reactive gas comprises a xenon fluoride species.

15. The method of claim 14, wherein chemically modifying the residual organometal oxyhalide species and selectively etching the modified residual species are performed concurrently.

16. The method of claim 11, wherein chemically modifying the residual organometal oxyhalide species and selectively etching the modified residual species do not overlap in time.

17. A processing system comprising:
a processing chamber;
a substrate holder disposed in the processing chamber and configured to support a substrate comprising a metal oxide layer exposed at a frontside of the substrate;
a process gas source fluidically coupled to the processing chamber and configured to flow a halogen-containing process gas;
a reactive gas source fluidically coupled to the processing chamber and configured to flow a reactive gas; and
a controller operationally coupled to the process gas source and the reactive gas source, the controller comprising one or more processors and at least one non-transitory computer-readable medium storing a program including instructions that, when executed by the one or more processors, cause the processing system to
process the metal oxide layer using the halogen-containing process gas to form a processed metal oxide layer comprising residual halogen species, and
chemically modify the residual halogen species to form modified residual species using the reactive gas to decontaminate the residual halogen species.

18. The processing system of claim 17, wherein the processing system is a plasma processing system, and wherein the instructions further cause the plasma processing system to
dry develop the metal oxide layer using plasma excited from the halogen-containing process gas, the processed metal oxide layer being a patterned metal oxide layer.

19. The processing system of claim 18, further comprising:
a dinitrogen-containing (N₂-containing) precursor source fluidically coupled to the processing chamber and configured to flow an N₂-containing precursor,
wherein the instructions further cause the plasma processing system to
selectively etch the modified residual species using a direct N₂ plasma excited from the N₂-containing precursor to remove the modified residual species from the patterned metal oxide layer, wherein chemically modifying the residual halogen species is performed without exciting plasma.

20. The processing system of claim 17, wherein the processing system is a chemical processing system, and wherein processing the metal oxide layer and chemically modifying the residual halogen species are both performed without exciting plasma.
